(19) United States
(12) Patent Application Publication
(10) Pub. No.: US 2004/0229108 A1
(43) Pub. Date: Nov. 18, 2004

(54) Anode structure for direct methanol fuel cell

(76) Inventors: Thomas I. Valdez, Covina, CA (US); Sekharipuram R. Narayanan, Arcadia, CA (US)

Correspondence Address: FISH & RICHARDSON, PC, 12390 EL CAMINO REAL, SAN DIEGO, CA, 92130-2081, US

(21) Appl. No.: 10/704,203

(22) Filed: Nov. 7, 2003

Related U.S. Application Data
(60) Provisional application No. 60/425,035, filed on Nov. 8, 2002.
(60) Provisional application No. 60/424,737, filed on Nov. 8, 2002.

(51) Int. Cl. H01M 4/86; H01M 4/90; H01M 4/88; H01M 4/96; B05D 5/12; H01B 1/08

(52) U.S. Cl. 429/40; 429/42; 427/115; 502/101; 429/44; 252/519.13

(57) ABSTRACT

Techniques and compositions for forming an anode electrode having reduced catalyst loading are described herein. These techniques optimize the operation of the anode for use in fuel cells. Formation techniques for the anode are also described herein as well as fuel systems that use the anode.

### CROSS REFERENCE TO RELATED APPLICATIONS

The invention claims priority under 35 U.S.C. §119 to provisional application Ser. Nos. 60/425,035, and 60/424,737, both filed Nov. 8, 2002, the disclosures of which are incorporated herein by reference.

### STATEMENT REGARDING FEDERALLY SPONSORED RESEARCH

The invention was funded in part by Grant No. NAS7-1407 awarded by NASA. The government may have certain rights in the invention.

### TECHNICAL FIELD

This disclosure relates to fuel cells, and more particularly to improved fuel cells comprising a novel anode.

### BACKGROUND

Transportation vehicles that operate on gasoline-powered internal combustion engines have been the source of many environmental problems. The output products of internal combustion engines cause, for example, smog and other exhaust gas-related problems. Various pollution control measures minimize the amount of certain undesired exhaust gas components. However, these control measures are not 100% effective.

Even if the exhaust gases could be made totally benign, however, the gasoline based internal combustion engine still relies on non-renewable fossil fuels. Many groups have searched for an adequate solution to these energy problems.

One possible solution has been fuel cells. Fuel cells chemically react using energy from a renewable fuel material. Methanol, for example, is a completely renewable resource. Moreover, fuel cells use an oxidation/reduction reaction instead of a burning reaction. The end products from the fuel cell reaction are mostly carbon dioxide and water.

### SUMMARY

The disclosure provides a proton-electron conducting ink for a fuel cell comprising hydrous ruthenium oxide.

Also provided by the disclosure is a process for making a proton-electron conducting ink for a fuel cell, comprising mixing components comprising ruthenium oxide, an ionomer solution and water.

The disclosure further provides a process for making a membrane electrode assembly for a fuel cell. The process comprises providing a proton-electron conducting ink comprising water, ruthenium oxide, and an ionomer material, and applying the proton-electron conducting ink at room temperature to at least one side of a substrate.

Also provided by the disclosure is a fuel cell electrode comprising a backing material, a catalyst layer, and a proton-electron conducting layer comprising ruthenium oxide on the backing material.

A membrane electrode assembly (MEA) is also provided by the disclosure. The MEA comprises an anode electrode comprising a backing material and a first catalyst; a proton conducting electrolyte membrane comprising a proton-electron conducting layer of hydrous ruthenium oxide; and a cathode electrode comprising a second catalyst; wherein the anode, cathode and electrolyte membrane are press bonded to one another in that order so that the electrolyte membrane is between the anode and cathode electrodes and wherein the proton-electron conducting layer is in contact with the catalyst layer of the anode.

The disclosure also provides a fuel cell comprising an anode and a cathode chamber; a proton conducting membrane comprising a proton-electron conducting layer of hydrous ruthenium oxide separating the anode and cathode chambers; and at least anode and cathode electrodes, wherein the electrodes include a backing material, and a catalyst layer in electrical communication with the proton conducting membrane, and wherein the catalyst layer of the anode is in contact with the proton-electron conducting layer comprising hydrous ruthenium oxide.

The details of one or more embodiments are set forth in the accompanying drawings and the description below. Other features, objects, and advantages will be apparent from the description and drawings, and from the claims.

### DESCRIPTION OF DRAWINGS

FIG. 1 is a prior art general schematic of a fuel cell.

FIG. 2A-E shows schematics of membrane electrode assemblies (MEAs). FIG. 2E shows the MEA of FIG. 2D in further detail.

FIG. 3 shows a plot of performance of direct methanol fuel cell using an anode provided by the disclosure.

FIG. 4 is a plot of the effect cathode structure has on the cell performance of a direct methanol fuel cell (DMFC) operating at 60° C., 0.5M MeOH, and ambient pressure air.

FIG. 5 shows a plot of cell efficiency and peak power densities as a function of applied current density for a type 1, 2, and 3 (see FIG. 2A-C) DMFC operating at 60° C., 0.5M MeOH, and ambient pressure air.

FIG. 6 is a Tafel plot of electrode potential as a function of applied current density for a Type 1 and Type 2 (see FIG. 2A-B) DMFC operating at 60° C., 0.5M MeOH, 0.1 LPM ambient pressure air.

FIG. 7 is a plot of effective crossover rate as a function of applied current density for a DMFC fabricated with a mechanical roughened and unroughened PEM operating at 60° C. on 0.5M MeOH.

FIG. 8 is a plot of a cell performance as a function of airflow rate and applied current density for a Type 2 DMFC operated at 60° C., 0.5 MeOH, ambient pressure air.

FIG. 9 is a plot of cell power as a function of airflow rate and applied current density for a Type 2 DMFC operated at 60° C., 0.5 M MeOH, ambient pressure air.

FIG. 10 is a plot of cell efficiency as a function of airflow rate and applied current density for a Type 2 DMFC operated at 60° C., 0.5M MeOH, and ambient pressure air.

FIG. 11 is a Tafel plot of cathode performance as a function of airflow rate and applied current density for a Type 2 DMFC operating at 60° C., 0.5M MeOH, ambient pressure air.

Like reference symbols in the various drawings indicate like elements.

### DETAILED DESCRIPTION

A liquid feed organic fuel cell comprises a housing having an anode, a cathode and a proton-conducting electrolyte membrane. As will be described in more detail below, the anode, cathode and the electrolyte membrane are typically a single multi-layer composite structure, often referred to as a membrane-electrode assembly or MEA. A pump circulates an organic fuel and water solution into a chamber in contact with the anode. The organic fuel and water mixture is re-circulated through a re-circulation system, which includes a methanol tank. Carbon dioxide formed in the anode compartment is vented out of the system. An oxygen or air compressor feeds oxygen or ambient air into a chamber in contact with the cathode.

Both the anode and cathode in the fuel cell comprise catalyst materials used in the electro-chemical reactions at each electrode. The catalysts for the electro-oxidation of the fuel at the anode have typically been selected from a number of materials including platinum-ruthenium alloy. The cathode catalyst for the electro-reduction of oxygen can use materials such as platinum. It is desirable to form a good mechanical and electrical contact between a catalyst material and the electrolyte membrane surface in order to achieve a high operating efficiency. An electrically conducting porous backing layer is typically used to collect the current from the catalyst layer and supply reactants to the membrane catalyst interface. A catalyst layer, therefore, can be formed on the backing layer. The backing layer can be made of various materials including a carbon fiber sheet.

The anode of a direct methanol fuel cell sustains the electro-oxidation of methanol to carbon dioxide according to the reaction:

CH₃OH+H₂O→CO₂+6H⁺+6e⁻

In order for the above electro-chemical reaction to occur efficiently, an electrocatalyst is required. Historically, the catalyst, with the highest activity, is an alloy of platinum and ruthenium with a 50:50 atom ratio. The anode structure is a composite prepared by combining high surface area platinum-ruthenium alloy particles and proton conducting ionomer material. Such a composite layer is usually deposited on the membrane and electrode structures.

Typically the total amount of noble metal catalyst used is about 8 mg/cm² to achieve high performance. While such significant amounts of noble metal are necessary for achieving high performance, not all of the noble metal is utilized in the catalytic process. Reducing the catalyst loading and improving the utilization of the catalyst is thus important for lowering cost and enhancing performance. The use of electronic conductors such as carbon in the catalyst layer has been proposed for improving the electrical connectivity between the particles. However, the relatively low density of carbon results in thick catalyst layers that impede mass transport of methanol to the catalytic sites. Also, carbon is at least 300 times less conducting than that of metallic substances. Furthermore, most metals are not stable in contact with the acidic proton-exchange membrane and therefore cannot be used. In addition, use of an electronic conductor does not facilitate the transport of protons produced in the electro-oxidation reaction in addition to electrons. A stable and simultaneous electronic and proton conductor is desirable.

Techniques and compositions for forming an anode electrode having reduced catalyst loading are described herein. These techniques optimize the operation of the anode for use in fuel cells. Formation techniques for the anode are also described herein as well as fuel systems that use an anode of the disclosure.

Hydrous ruthenium oxide is an electronic and proton conductor. Its density is comparable to that of the platinum-ruthenium catalyst currently used in fuel cell systems. Hydrous ruthenium oxide is also stable in contact with acidic membranes such as Nafion. Therefore, hydrous ruthenium oxide when combined with ionomeric Nafion and layered on the membrane overcomes many of the problems with the platinum-ruthenium catalyst alone currently being employed in fuel cells.

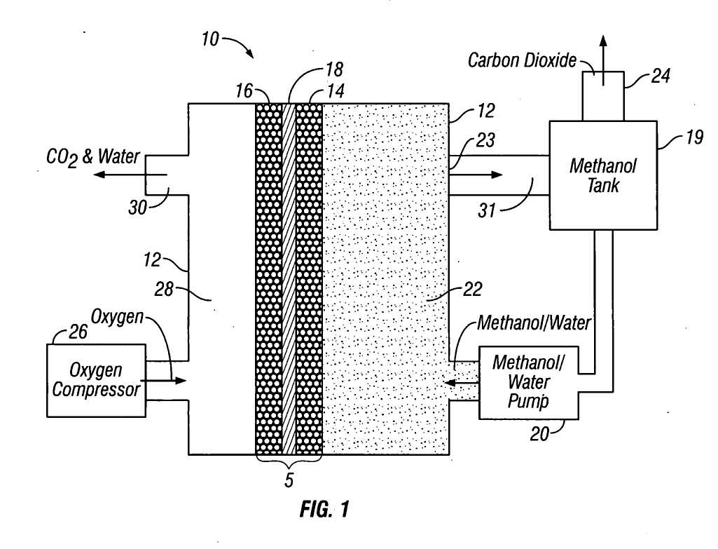

FIG. 1 illustrates a general liquid feed organic fuel cell 10 having a housing 12, an anode 14, a cathode 16 and a polymer electrolyte membrane 18 (e.g., a solid polymer proton-conducting cation-exchange electrolyte membrane). As will be described in more detail below, anode 14, cathode 16 and polymer electrolyte membrane 18 can be a single multi-layer composite structure, sometimes referred to as a membrane-electrode assembly or MEA (depicted in FIG. 1 as reference numeral 5). A pump 20 is provided for pumping an organic fuel and water solution into an anode chamber 22 of housing 12. The organic fuel and water mixture is withdrawn through an outlet port 23 and is re-circulated through a re-circulation system which includes a methanol tank 19. Carbon dioxide formed in the anode compartment is vented through a port 24 within tank 19. An oxygen or air compressor 26 is provided to feed oxygen or air into a cathode chamber 28 within housing 12. The following detailed description of the fuel cell of FIG. 1 primarily focuses on the structure and function of anode 14, cathode 16 and membrane 18.

Prior to use, anode chamber 22 is filled with an organic fuel and water mixture and cathode chamber 28 is filled with air and/or oxygen. During operation, the organic fuel is circulated past anode 14 while oxygen and/or air is pumped into chamber 28 and circulated past cathode 16. When an electrical load is connected between anode 14 and cathode 16, electro-oxidation of the organic fuel occurs at anode 14 and electro-reduction of oxygen occurs at cathode 16. The occurrence of different reactions at the anode and cathode gives rise to a voltage difference between the two electrodes. Electrons generated by electro-oxidation at anode 14 are conducted through the external load and are ultimately captured at cathode 16. Hydrogen ions or protons generated at anode 14 are transported directly across the electrolyte membrane 18 to cathode 16. Thus, a flow of current is sustained by a flow of ions through the cell and electrons through the external load.

The fuel cell described herein comprises an anode, cathode, and a membrane, all of which can form a single composite layered structure. The electrolyte membrane may be of any material so long as it has the ability to separate the solvents of the fuel cell and retains proton-conducting capability. One such membrane, for example is Nafion, a perfluorinated proton-exchange membrane material. Nafion is a co-polymer of tetrafluroethylene and perflurovinylether sulfonic acid. Other membrane material can also be used as described in U.S. Pat. No. 5,795,596, the disclosure of which is incorporated herein. Additionally, membranes of modified perfluorinated sulfonic acid polymer, polyhydrocarbon sulfonic acid and composites of two or more kinds of proton exchange membranes can be used.

The anode structure for liquid feed fuel cells is different from that of conventional fuel cells. Conventional fuel cells employ gas diffusion type electrode structures that can provide gas, liquid and solid equilibrium. However, liquid feed type fuel cells require anode structures that are similar to batteries. The anode structures must be porous and must be capable of wetting the liquid fuel. In addition, the structures must have both electronic and ionic conductivity to effectively transport electrons to the anode current collector (carbon paper) and hydrogen/hydronium ions to, for example, a Nafion™ electrolyte membrane. Furthermore, the anode structure must help achieve favorable gas evolving characteristics at the anode.

In one embodiment, an MEA comprising ruthenium oxide on the anode side of the polymer electrolyte membrane is provided. The ruthenium oxide increases proton-electron conductivity at the anode and thus improves fuel cell performance.

An anode comprises hydrous ruthenium oxide applied as an ink to a support backing and/or the polymer electrolyte membrane. A layer of hydrous ruthenium oxide can be applied to a high surface area carbon backing such as Toray 060® carbon paper. In one aspect, the backing may further comprise approximately five to six weight percent Teflon. Other high surface area carbon backing may comprise material such as Vulcan XC-72A, provided by Cabot Inc., USA. In another embodiment, the ruthenium oxide is applied to one side (i.e., the anode side) of the polymer electrolyte membrane. The catalyst surface of the carbon fiber sheet backing is used to make electrical contact with the hydrous ruthenium oxide on the membrane. In yet another aspect, the ruthenium oxide is applied to both the polymer electrolyte membrane and the carbon backing/catalyst of the anode. The ruthenium oxide promotes/increases the efficiency of proton and electron conductivity at the anode.

The anode can be made by generating a hydrous ruthenium oxide ink with consistency suitable for painting. The ink can be made by sonicating a mixture of 0.140 g of ruthenium oxide, 0.720 g of Nafion ionomer solution and 0.400 g of water. A layer of ruthenium oxide ink is then applied to the electrolyte membrane and/or the support backing comprising a catalyst. Where the hydrous ruthenium oxide ink is applied to the support backing, a layer containing catalyst (e.g., platinum-ruthenium) is first applied to the backing and the ruthenium oxide is then applied to the catalyst.

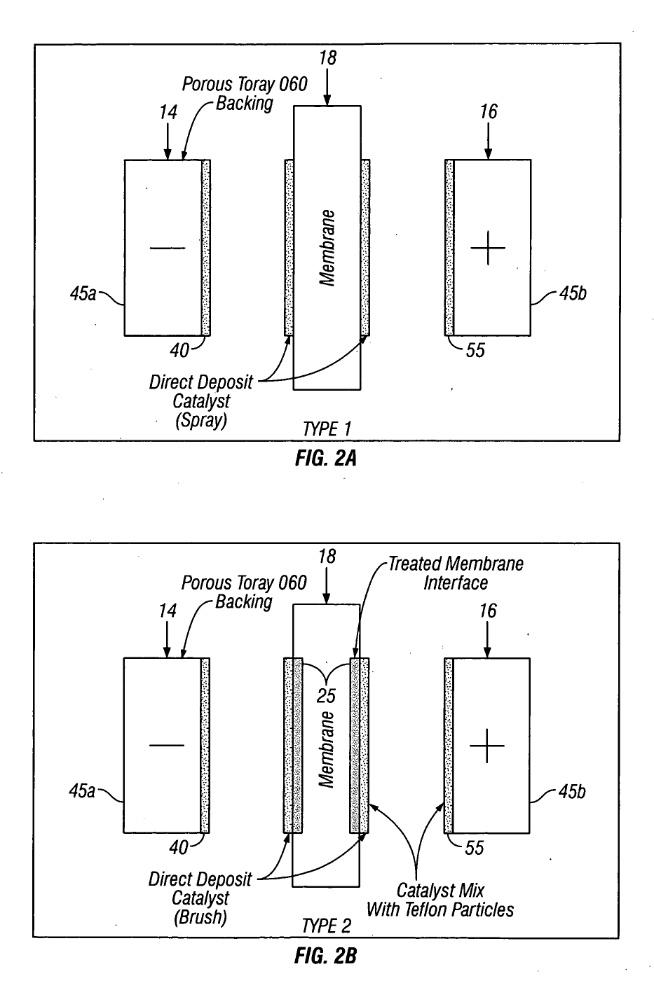

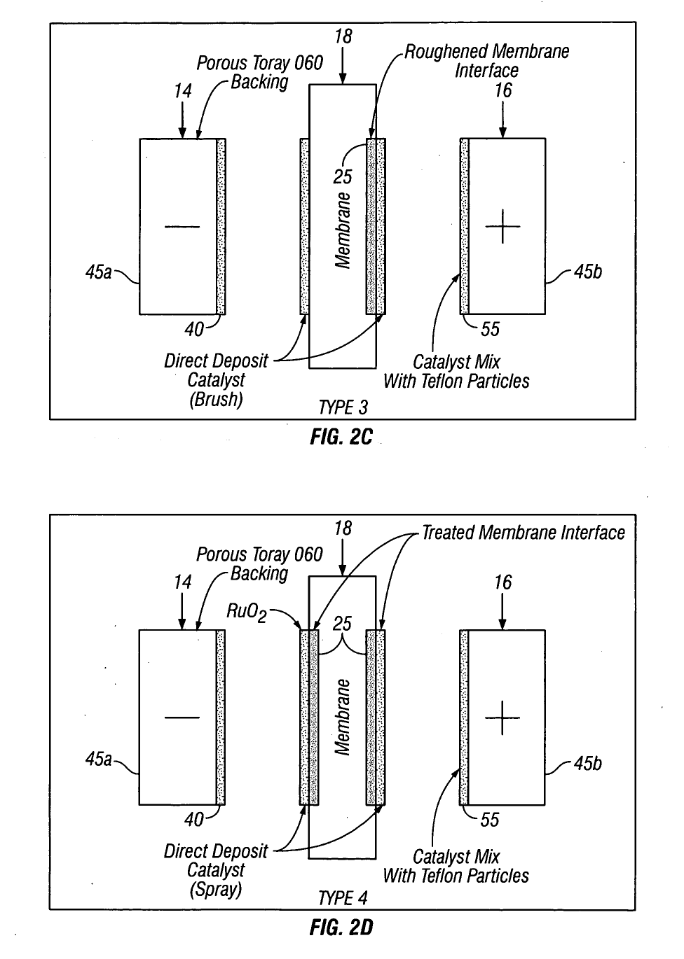

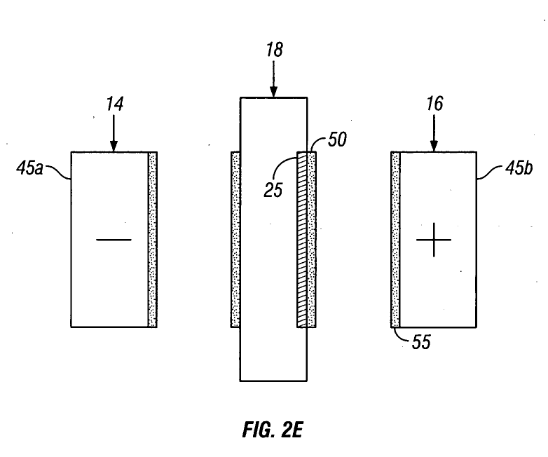

FIG. 2A-E shows various embodiments of a membrane electrode assembly (MEA). Each of FIGS. 2A-2E shows an anode 14, a cathode 16 and an electrolyte membrane 18 comprising support backings 45a and 45b and one or more catalyst layers.

Referring to FIG. 2 there is shown an MEA (see also FIG. 1 numeral 5) comprising an anode 14, a polymer electrolyte membrane 18, and a cathode 16. The anode surface of polymer electrolyte membrane 18 is roughened (indicated by reference 25) prior to brush-painting a layer of hydrous ruthenium oxide 30 onto the roughened surface 25. Catalyst 40 is applied to a support backing 45a (e.g., a high surface area carbon paper).

The electrocatalyst layer and carbon fiber support of anode 14 (FIG. 2) can be impregnated with a hydrophilic proton-conducting polymer additive such as Nafion™. The additive is provided within the anode, in part, to permit efficient transport of protons and hydronium produced by the electro-oxidation reaction. The ionomeric additive also promotes uniform wetting of the electrode pores by the liquid fuel/water solution and provides for better utilization of the electrocatalyst. The kinetics of methanol electro-oxidation by reduced adsorption of anions is also improved. Furthermore, the use of the ionomeric additive helps achieve favorable gas evolving characteristics for the anode.

For an anode additive to be effective, the additive should be hydrophilic, proton-conducting, electrochemically stable and should not hinder the kinetics of oxidation of liquid fuel. Ruthenium oxide satisfies these criteria and improves electron-proton conductivity. Nafion and other hydrophilic proton-conducting additives such as montmorrolinite clays, zeolites, alkoxycelluloses, cyclodextrins, and zirconium hydrogen phosphate can also be added to the anode.

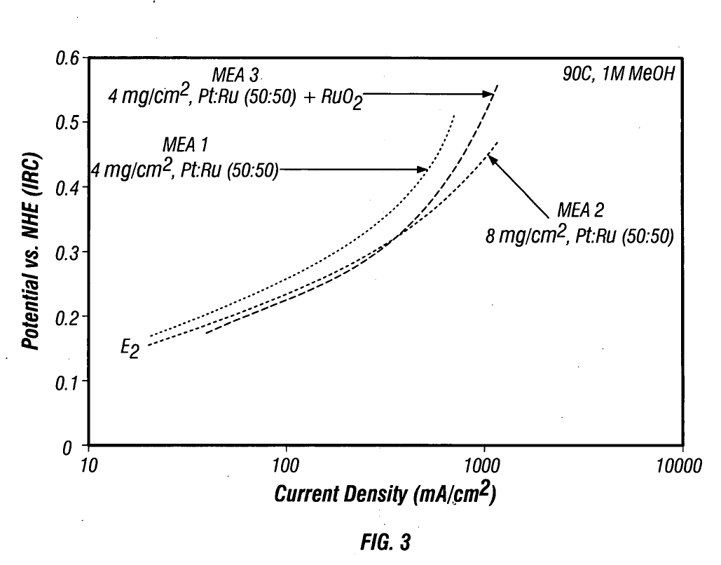

The anode uses less catalyst to provide the same low anode polarization as an anode with 100% more catalyst. The results show in FIG. 3 demonstrate that the anode with 4 mg/cm² and a hydrous ruthenium oxide layer show a low anode polarization and to the same extent as the anode with 8 mg/cm² of catalyst. This corresponds to an improvement in utilization of the catalyst of 100%. Fuel cells made using an anode provided by the disclosure are shown to operate continuously for several hours and with no degradation in performance, suggesting the ruthenium oxide is a stable material. The overall internal resistance of the fuel cell with an electrode area of 25 cm² was 4.6 mOhm, one of the lowest, attesting to the excellent protonic and electronic conductivity of ruthenium oxide.

An anode is formed as follows. A catalyst material comprising, for example, platinum-ruthenium alloy is sintered to a backing material (e.g., Toray 060 paper). In some aspect, a free-catalyst layer can be layered on the sintered layer. As used herein, “sintering” refers to the process of heating without melting. A proton conducting membrane is then roughened with an abrasive, followed by applying a proton-electron conducting material (e.g., ruthenium oxide) to the roughened polymer electrolyte membrane surface. The backing comprising the catalyst and the electrolyte membrane comprising the proton-electron conductor are then heat pressed to one another. The sintered catalyst material may additionally include a waterproofing amount of Teflon. Any catalyst suitable for undergoing oxidation-reduction is suitable for use (e.g., platinum).

Referring again to FIG. 2E, the anode 14 is an electrode in which a catalyst 40 (e.g., platinum-ruthenium particles) is applied to one side of a support backing 45a (e.g., a high surface area carbon paper such as Toray 060). In some embodiments, a further layer of ruthenium oxide is then applied to the catalyst layer 40. A polymer electrolyte membrane 18 is roughened (generally depicted by 25) with an abrasive such as, for example, silicon nitride, boron nitride, silicon carbide, silica and boron carbide on the anode side. The roughened portion 25 of the anode side of the polymer electrolyte membrane is then coated with an ink comprising an electron-proton conducting material (e.g., a hydrous ruthenium oxide ink) 30. Application of these layers can be performed in any number of ways, for example by painting using a camel hair brush as described herein, or alternatively by spraying. The catalyst-coated support backing is then bonded to one side of the electrolyte membrane 18 comprising the electron-proton conducting material. Thus, the anode has a catalyst layer 40, painted on a support backing 45a and a proton-electron conducting layer (e.g., ruthenium oxide) painted on a roughened polymer electrolyte membrane 18. The catalyst layer 40 can be sintered to the support backing 45a to immobilize the catalyst. The electrolyte membrane 18 (e.g., Nafion) comprises a ruthenium oxide layer 30 that is applied to the sintered-catalyst covered anode before hot pressing. This approach results in an anode having four layers, i.e. a backing layer 45a, a sintered catalyst layer 40, a ruthenium oxide layer 30, and an electrolyte membrane layer 18.

The cathode 16 is a gas diffusion electrode in which a catalyst 55 (e.g., platinum particles) is applied to one side of a support backing 45b (e.g., a high surface area carbon paper such as Toray 060). The platinum-coated support backing can be bonded to one side of the electrolyte membrane 18. Thus, the cathode has a single catalyst layer 55, painted on a support backing 45b. The catalyst layer 55 is sintered to the support backing 45b to immobilize the catalyst. The electrolyte membrane 18 (e.g., Nafion) is then applied to the sintered-catalyst covered cathode before hot pressing. This approach results in a cathode having three layers, i.e. a backing layer 45b, a sintered catalyst layer 55, and an electrolyte membrane layer 18. Platinum-based alloys in which a second metal is either tin, iridium, osmium, or rhenium can be used instead of platinum-ruthenium catalyst in the cathode. Unsupported platinum black (fuel cell grade) available from Johnson Matthey, Inc, USA or supported platinum materials available from E-Tek, Inc, USA are suitable for the cathode. In general, the choice of the alloy depends on the fuel to be used in the fuel cell. Platinum-ruthenium is used for electro-oxidation of methanol. For platinum-ruthenium, the loading of the alloy particles in the electrocatalyst layer is typically in the range of 0.5-4.0 mg/cm². More efficient electro-oxidation is realized at higher loading levels, rather than lower loading levels.

In one aspect, impregnated electrodes are formed. To form impregnated electrodes from electrocatalyst particles, the electrocatalyst particles are mixed in with a solution of Nafion™ diluted to 1% with isopropanol. Then the solvent is allowed to evaporate until a thick mix is reached. The thick mix is then applied onto a Toray™ paper to form a thin layer of the electrocatalyst. A mixture of about 200 M²/gram high surface area particles applied to the Toray™ paper is exemplary. Electrodes so prepared are then dried in a vacuum at 60° C. for 1 hour to remove higher alcohol residues, after which they are ready for use in liquid feed cells.

A commercially available high-surface area platinum-tin electrode can be impregnated with Nafion™ according to the procedure described above.

The electrodes are typically formed using a base of carbon paper. For example, the starting material can be TGPH-090 carbon paper available from Toray, 500 Third Avenue, New York, N.Y. This paper may be pre-processed to improve its characteristics (e.g., using a DuPont “Teflon 30” suspension of about 60% solids).

The paper can alternately be chopped carbon fibers mixed with a binder. The fibers are rolled and then the binder is burned off to form a final material, which is approximately 75% porous. Alternately, a carbon paper cloth could be used. This will be processed according to the techniques described herein to form a gas diffusion/current collector backing.

The anode assembly is formed on a carbon paper base. This carbon paper can be teflonized, meaning that TEFLON is added to improve its properties. The paper is teflonized to make it water repellent, and to keep ink mix from seeping through the paper. The paper needs to be wettable, but not porous.

Two techniques of application of the catalyst layer are described herein. A direct application and a sputtering application can be used. Both can use the special carbon paper material whose formation was described above, or other carbon paper including carbon paper, which is used without any special processing. The direct application technique mixes materials comprising hydrous ruthenium oxide catalyst materials. The catalyst materials may be processed with additional materials, which improve the characteristics.

For preparation of the anode, a ruthenium oxide powder is mixed with an ionomer and with a water repelling material. For example, a mixture of 0.140 g of ruthenium oxide, 0.720 g of Nafion ionomer solution and 0.400 g of water is made. The resultant mixture is then mixed using an ultrasonic mixing technique—known in the art as “sonicating”. The ultrasonic mixing is done in an ultrasonic bath filled with water to a depth of about 1/4 inch. The mixture is “ultrasonicated” for about 4 minutes.

Alternatively, the anode may also include a Nafion material. In this instance the Teflon is first mixed with the ruthenium oxide as described above to form about 15% by weight TEFLON. After this mixture is made the Nafion is added. At this point, 0.72 grams of 5 weight percent Nafion is added and sonicated again for 4 minutes. More generally, approximately 1 mg of Nafion needs to be added per square cm of electrode to be covered. The amount of TEFLON described above may also be modified, e.g. by adding only 652 ml of the solution.

This process forms a slurry or ink of black material. This slurry of black material is then applied to the carbon paper and/or electrolyte membrane (anode side). The application can take any one of a number of forms. The simplest form is to paint the material on the substrate, using alternating strokes in different directions. A small camel hair brush is used to paint this on. The material amounts described above form enough catalyst for one side of a 2-inch by 2-inch piece of substrate. Accordingly, the painting is continued until all the catalyst is used.

A drying time of two to five minutes between coats should be allowed, so that the material is semi-dried between coats and each coat should be applied in a different direction. The anode then needs to dry for about 30 minutes. After that 30 minutes, the anode must be “pressed”.

The resulting structure is a porous carbon substrate used for diffusing gases and liquids, covered by 4 mg per square cm of catalyst material.

An alternative technique of applying the materials sputters the materials onto the backing.

The cathode electrode carries out a reaction of O₂+H⁺+e⁻→H₂O. The O₂ is received from the ambient gas around the platinum electrode or by directly pumping purified or substantially pure O₂ to contact the cathode, while the electron and protons are received through the membrane or the circuit load. The cathode is constructed by first preparing a cathode catalyst ink. The cathode catalyst ink is typically pure platinum, although other inks can be used and other materials can be mixed into the ink as described herein. An amount equal to about 250 mg of platinum is used for the cathode assembly. This is divided between the sintered catalyst layer and unsintered catalyst layer. For the sintered layer about 125 mg of platinum catalyst is mixed with about 0.25 gram of water, if TEFLON is to be included, typically 18.6 mg of TEFLON although this can range from about 1 mg to about 40 mg, is added. The relative ratios of platinum to water to TEFLON will vary depending upon the requirements of the fuel cell and cathode assembly. These ratio are easily determined by those skilled in the art. The mix is sonicated for five minutes as described above. This forms enough material to cover one piece of 2×2 inch carbon paper. Unprocessed Toray carbon paper can be used. The carbon paper may be teflonized as discussed above. Platinum catalyst ink is then applied to the paper as described above to cover the material with 2 mg/cm²/g of Pt. Teflon content of the paper can vary from 3-20%. The paper is then heated at 300° C. for one hour to sinter the catalyst and, if present, TEFLON particles.

The carbon-catalyst sintered paper is then used as the substrate for the addition of the free-catalyst layer. By “free-catalyst” or “unsintered catalyst” is meant a layer comprising catalyst, such as platinum, that is highly active, having open catalyst sites and which is in direct contact with the polymer proton-conducting membrane after hot pressing. The free-catalyst layer or unsintered catalyst layer is prepared by mixing the remaining amount of platinum, i.e. the unused portion of catalyst remaining after preparing the sintered layer, with water and can also include a 5% Nafion solution. For example, 125 mg of platinum is mixed with 0.25 gram of water. The mix is sonicated for five minutes and combined with a 5% solution of Nafion. The mix is again sonicated for five minutes to obtain a uniform dispersal. This second free-catalyst layer is applied to the carbon-catalyst sintered paper. Application can be performed by any number of means including painting, spraying (other methods are known to those skilled in the art). The free-catalyst layer is allowed to dry whereupon it is hot pressed to the proton-conducting membrane.

An alternative technique of cathode forming utilizes a sputtered platinum electrode. This alternative technique for forming the cathode electrode starts with fuel cell grade platinum. This can be bought from many sources including Johnson-Matthey. 20 to 30 gms per square meter of surface area of this platinum are applied to the electrode at a particle size of 0.1 to 1 micron. The material is sputtered onto the substrate prepared as described above. For example, a platinum-aluminum material is sputtered onto the carbon substrate using techniques known in the art. The resulting sputtered electrode is a mixture of Al and Pt particles on the backing. The electrode is washed with potassium hydroxide (KOH) to remove the aluminum particles. This forms a carbon paper backing with very porous platinum thereon. Each of the areas where the aluminum was formed is removed—leaving a pore space at that location. Typically the coating of platinum-aluminum is thin (e.g., about 0.1 micron coating or less with a material density between 0.2 mg per cm² and 0.5 mg per cm². This sputtering technique is useful in the formation of the first layer, e.g. the sintered layer, of the cathode. Further processing to provide for the free-catalyst layer is performed using the methods described above.

At this point, we now have an anode, a membrane, and a cathode. These materials are assembled into a membrane electrode assembly (“MEA”)

The electrodes and the membrane are first laid or stacked on a CP-grade 5 Mil, 12-inch by 12-inch titanium foil. Titanium foil is used to prevent any acid content from the membrane from leaching into the stainless steel plates.

First, the anode electrode is laid on the foil. The proton conducting membrane has been stored wet to maintain its desired membrane properties. The proton conducting membrane is first mopped dry to remove any macro-sized particles. The membrane is then laid directly on the anode. The cathode is laid on top of the membrane. Another titanium foil is placed over the cathode.

The edges of the two titanium foils are clipped together to hold the layers of materials in position. The titanium foil and the membrane between which the assembly is to be pressed includes two stainless steel plates which are each approximately 0.25 inches thick.

The membrane and the electrode in the clipped titanium foil assembly is carefully placed between the two stainless steel plates. The two plates are held between jaws of a press such as an arbor press or the like. The press should be maintained cold, e.g. at room temperature.

The press is then actuated to develop a pressure between 1000 and 1500 psi, with 1250 psi being an optimal pressure. The pressure is held for 10 minutes. After this 10 minutes of pressure, heating is commenced. The heat is slowly ramped up to about 146° C.; although anywhere in the range of 140-150° C. has been found to be effective. The slow ramping up should take place over 25-30 minutes, with the last 5 minutes of heating being a time of temperature stabilization. The temperature is allowed to stay at 146° C. for approximately 1 minute. At that time, the heat is switched off, but the pressure is maintained.

The press is then rapidly cooled using circulating water, while the pressure is maintained at 1250 psi. When the temperature reaches 45° C., approximately 15 minutes later, the pressure is released. The bonded membrane and electrodes are then removed and stored in de-ionized water.

Each membrane electrode assembly (“MEA”) 5 is sandwiched between a pair of flow-modifying plates which include biplates and end plates. A flow of fuel is established in each chamber 22 and 28 immediately next to the electrodes (see FIG. 1). Membrane electrode assemblies 5, as described includes an anode 14, a membrane 18, and a cathode 16. The anode side of each membrane electrode assembly is in contact with an aqueous methanol source in chamber 22. The cathode side of each membrane electrode assembly is in contact with an oxidant air source in chamber 28, which provides the gaseous material for the reactions discussed above. The air can be plain air or can be oxygen.

Flow and circulation of these raw materials maintain proper supply of fuel to the electrode. It is also desirable to maintain the evenness of the flow.

What has been described thus far is an improved liquid feed fuel cell anode comprising hydrous ruthenium oxide. In some embodiment, the anode is impregnated with an ionomeric additive. A method for fabricating the anode has also been described. Further understanding may be obtained from the following examples which are not intended to limit the disclosure.

### EXAMPLES

Several MEAs were fabricated by variations in direct deposit techniques as described herein. This technique involved the brush painting and spray coating of catalyst layers on the membrane and the gas diffusion backing followed by drying and hot pressing and is to be distinguished from other widely used techniques such as the “decal technique” used to prepare MEAs. Each of these MEAs consisted of a Pt—Ru black (50:50) anode, a Pt-black cathode, and Nafion 117® as the polymer electrolyte membrane (PEM). The catalyst used to fabricate these MEAs was purchased from Johnson Matthey. The MEAs studied had an active electrode area of 25 cm². The catalyst loadings for both the anode and the cathode were in the range of 8 to 12 mg/cm² unless noted otherwise. The gas diffusion backings and current collectors for all MEAs were made of Toray 060® carbon paper with approximately five to six weight percent Teflon content.

Variations in fabrication technique included mechanical roughening of the membrane, modifications to the catalyst layer, and changes to the catalyst application process. The catalyst constituents studied included hydrophobic particles and proton-conducting substances added to the catalyst mix. The four MEA fabrication techniques. studied are schematically shown as FIG. 2A-D.

In fabrication technique Type 1, anode and cathode catalyst are deposited on the membrane; the anode is spray-coated and no hydrophobic particles are dispersed in the cathode catalyst layer. In fabrication technique Type 2, the PEM was mechanically roughened on both the anode and cathode sides prior to the application of catalyst. In a Type 2 MEA, the anode is brush-painted and the hydrophobic particles are evenly dispersed within the cathode structure. In fabrication technique Type 3, only the cathode side of the PEM is roughened and the hydrophobic particles are concentrated only at the gas diffusion backing of the cathode structure. The anode of a Type 3 MEA is brush painted. In fabrication technique Type 4, a layer of hydrous ruthenium oxide (RuO₂) was brush-painted on to a roughened anode side of the PEM prior to the brush-painting of Pt—Ru catalyst; the cathode is prepared as in a Type 3 MEA.

The fabricated cells were then characterized in an DMFC test system. The DMFC test system consisted of a fuel cell test fixture, a temperature controlled circulating fuel solution loop and an oxidant supply from a compressed gas tank. The fuel cell test fixture, supplied by Electrochem Inc., accommodated electrodes with a 25-cm² active area and had pin-cushion flow fields for both the anode and cathode compartments. Crossover rates were measured using a Horiba VIA-5 10 CO₂ analyzer and are reported as an equivalent current density of methanol oxidation.

The electrical performance of DMFCs has been characterized by the evaluation of full cell performance, anode polarization, cathode polarization, and methanol crossover.

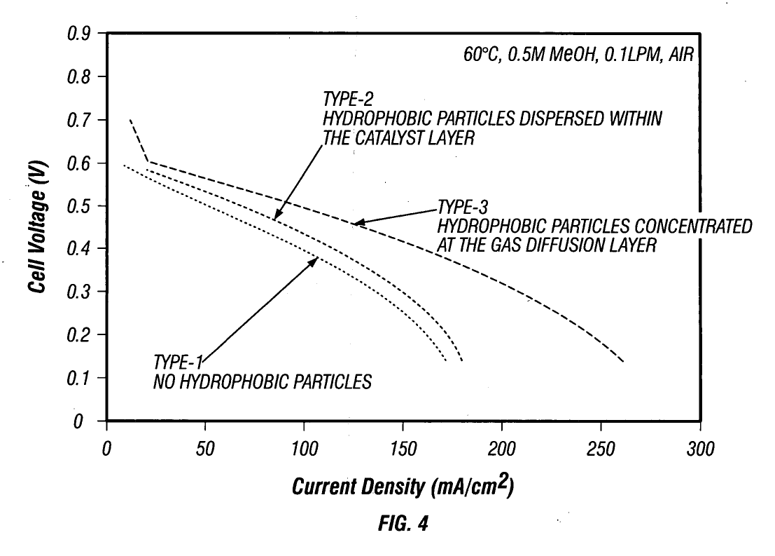

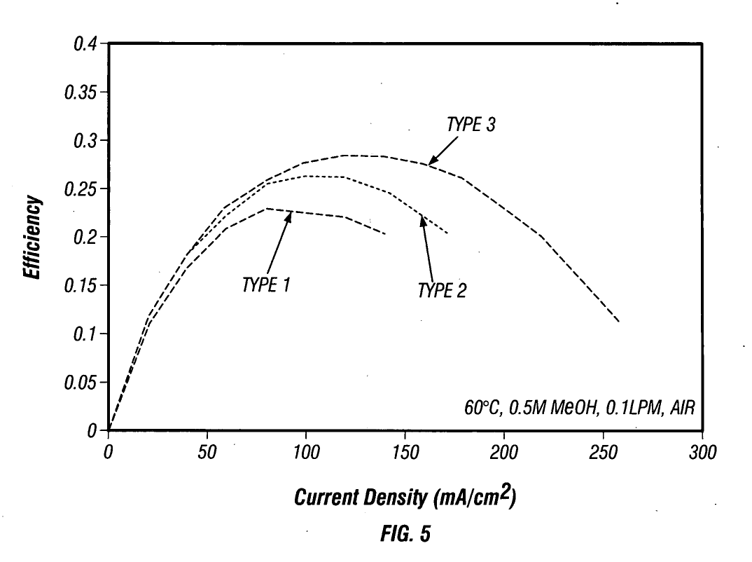

The results in FIGS. 4 and 5 suggest that the hydrophobic particles have a beneficial effect on cell performance at low airflow rates. Also, the location of the hydrophobic particles in the gas diffusion backing appears to be particularly beneficial in realizing high performance. As summarized in table 1, modifying the MEA electrode structures results in an 80% increase in peak power density and substantially improved cell efficiency.

TABLE 1

| MEA Type | | |
|---|---|---|
| 1 | 2 | 3 |

Peak Efficiency

| | | | |
|---|---|---|---|
| Cell Efficiency (%) | 23 | 27 | 29 |
| Cell Voltage (V) | 0.439 | 0.387 | 0.464 |
| Applied Current Density | 80 | 120 | 120 |
| (mA/cm²) | | | |
| Cell Power Density | 35.1 | 46.4 | 55.6 |
| (mW/cm²) | | | |

Peak Power

| | | | |
|---|---|---|---|
| Cell efficiency (%) | 23 | 25 | 27 |
| Cell Voltage (V) | 0.306 | 0.337 | 0.367 |
| Applied Current Density | 120 | 140 | 180 |
| (mA/cm²) | | | |
| Cell Power Density | 36.7 | 47.1 | 66.1 |
| (mW/cm₂) | | | |

The relative effects of anode and cathode modifications on performance can be analyzed by determining the contributions from the anode and cathode using anode polarization analysis. The effect of methanol crossover on the cathode performance in a DMFC has been studied. Crossover places an additional load on the cathode of having to oxidize the methanol that has crossed over. The mixed potential so arising at the cathode lowers the total cell efficiency. FIG. 5 is a plot of electrode potential versus the NHE as a function of applied current density for a Type 1, 2 and 3 MEA. The improvement in cell performance from the Type 1 to Type 2 MEAs can be seen as an increase in cathode performance for applied current densities lower than 100 mA/cm² and increase in anode performance for current densities greater than 40 mA/cm². The average increase in cathode performance between the Type 1 and Type 2 MEAs is 16 mV. The improvement in cathode performance observed between the Type 1 and Type 2 MEAs can be attributed to the hydrophobic particles allowing the oxidant easier access to the catalytic surfaces as well as increasing the water rejection rate in the Type 2 cathode structure. The average decrease in the anode over potential between the Type 1 and Type 2 MEAs is 40 mV. The increase in anode performance from the Type 1 to Type 2 is attributed to the anode fabrication technique. It has been observed that anodes fabricated by the spray processes exhibit higher anodic over potentials as compared to anodes fabricated by the brush technique. This change in anode performance is attributed to possible changes in ionomer/catalyst distribution within the anode structure as a result of the spraying technique.

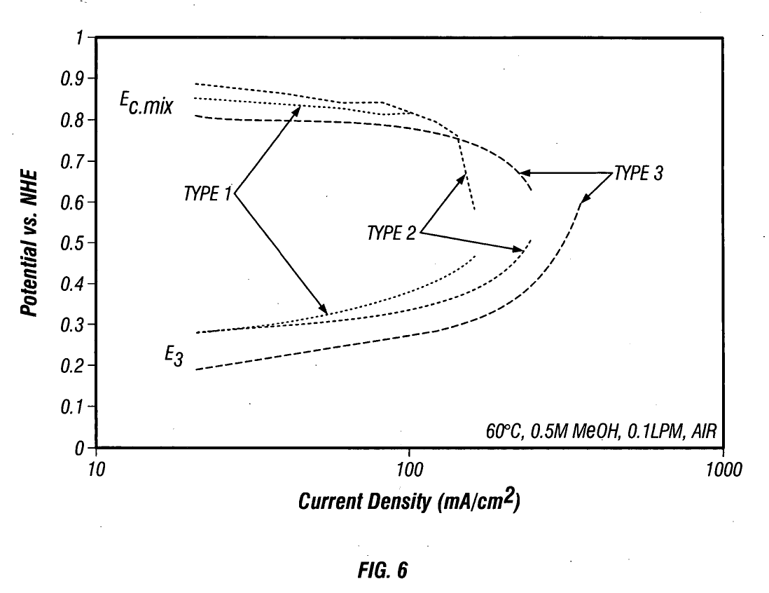

Results in FIG. 6 suggest that the improvement in cell performance from the Type 2 to Type 3 MEAs is attributed to improved cathode and anode performance. The anode potentials at the peak efficiency and peak power were 0.355, 0.285, 0.368, and 0.33V versus NHE for the Type 2 and Type 3 MEAs respectively. Mechanical roughening of the PEM prior to, deposition of the catalyst results in a very dense anode. The denser or the higher tortuosity of the anode can render catalyst sites inaccessible and thus manifest itself as lower anode performance. The increase in anode performance between the Type 2 and Type 3 MEA thus could be attributed to the density changes in the anode coating. For current densities less than 140 mA/cm² the performance of the cathode is lower for the Type 3 versus Type 2 MEA. However the cathode of the Type 3 MEA can sustain much higher currents than the cathode of the Type 2 MEA. The initial decrease in cathode performance observed for the Type 3 MEA may be attributed to catalyst variation and perhaps a minimal increase in crossover. Based on the results, the hydrophobic particles should be placed near the gas diffusion/oxidant interface to allow for increased water rejection at the cathode.

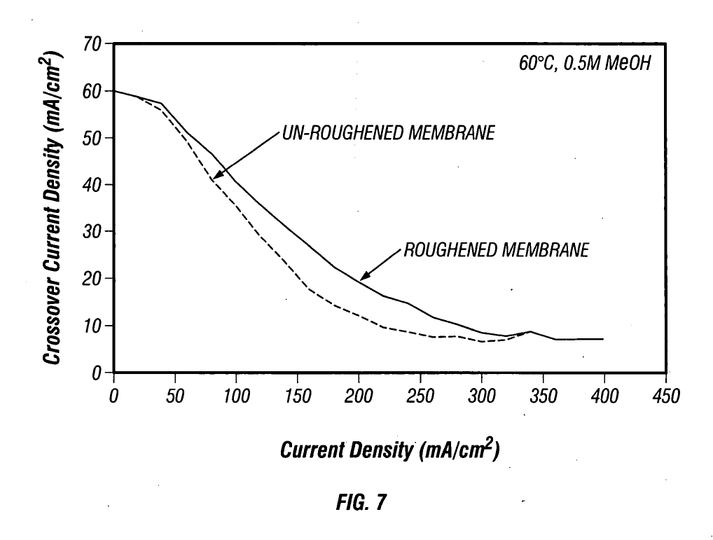

FIG. 7 is a plot of crossover current density versus applied current density for a DMFC fabricated with a mechanical roughened and un-roughened PEM. One of the factors that control crossover current density is membrane thickness. One would expect that the mechanical roughening of the membrane can lead to a thinner membrane and thus increased crossover. The average increase in crossover current density for a roughened and an un-roughened PEM is on the order of 5-10 mA/cm² over a wide range of current densities.

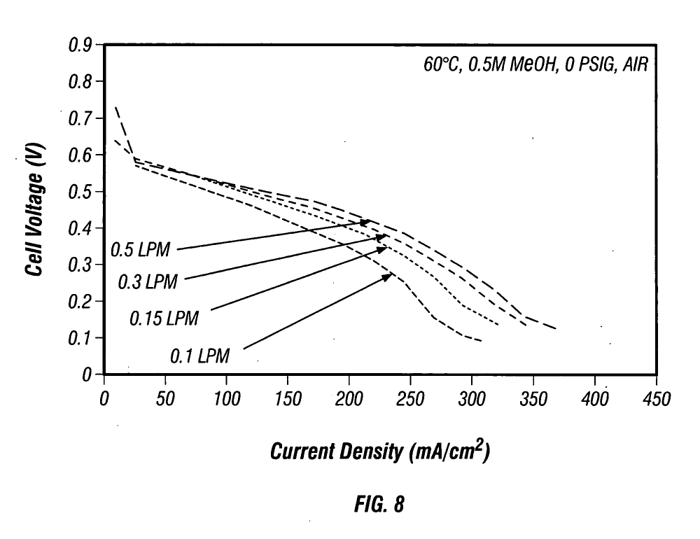

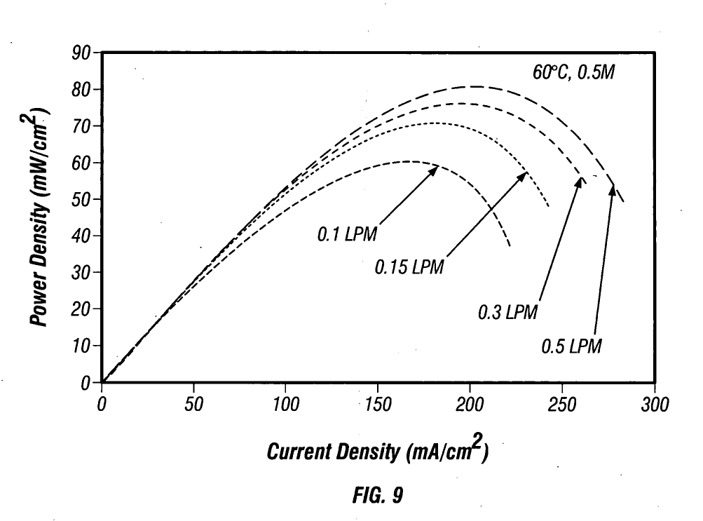

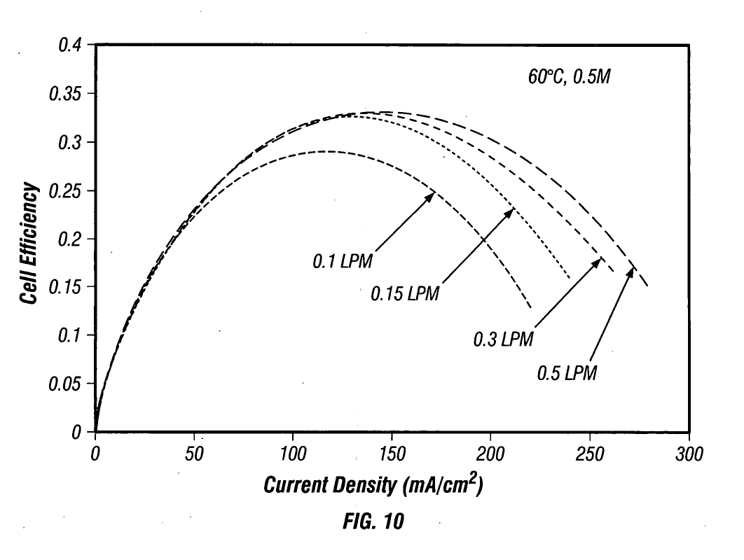

FIGS. 8, 9, and 10 are plots of cell performance, cell power density and cell efficiency versus applied current density respectively for a Type 3 MEA operated at 60° C., 0.5M MeOH, with ambient pressure air. Table 2 is a summary of the data in FIGS. 8, 9, and 10. The plots and table show that as the airflow to a DMFC is increased the cell performance, peak power, and efficiency all increase. As shown in table 2, for a 50% increase in airflow to the cell, from 0.1 to 0.15 LPM, a 19% increase in cell power density can be observed. Overall, for a five-fold increase in airflow a 37% increase in peak power density is observed. Similarly, the overall gains for in peak efficiency for the airflow range of 0.1 to 0.5 LPM are 30%. The gains in peak efficiency with increase in airflow are not as large as the gains observed for peak power. This is because the air stoichiometry (including crossover) at peak efficiency is in the range of 1.5 to 7 versus 1.3 to 5.4 times stoich in the case of peak power. The change in oxygen demand for the cell operating at peak power is greater than that for a cell operating at peak efficiency, leading to greater impact of airflow rate.

TABLE 2

| Airflow Rate (LPM | | | |
|---|---|---|---|
| 0.1 | 0.15 | 0.3 | 0.5 |

Peak Efficiency

| | | | | |
|---|---|---|---|---|
| Cell Efficiency (%) | 29 | 32 | 33 | 34 |
| Cell Voltage (V) | 0.44 | 0.45 | 0.47 | 0.49 |
| Applied Current Density | 120 | 140 | 140 | 140 |
| (mA/cm²) | | | | |
| Air Stoichiometry | 1.54 | 2.11 | 4.23 | 7 |
| (X × Stoich) | | | | |
| Cell Power Density | 52.8 | 63 | 65.8 | 68.6 |
| (mW/cm²) | | | | |

Peak Power

| | | | | |
|---|---|---|---|---|
| Cell efficiency (%) | 26 | 29 | 28 | 30 |
| Cell Voltage (V) | 0.367 | 0.389 | 0.375 | 0.4 |
| Applied Current Density | 160 | 180 | 200 | 200 |
| (mA/cm²) | | | | |
| Air Stoichiometry | 1.27 | 1.76 | 3.22 | 5.37 |
| (X × Stoich) | | | | |
| Cell Power Density | 58.6 | 70 | 75.2 | 80.2 |
| (mW/cm₂) | | | | |

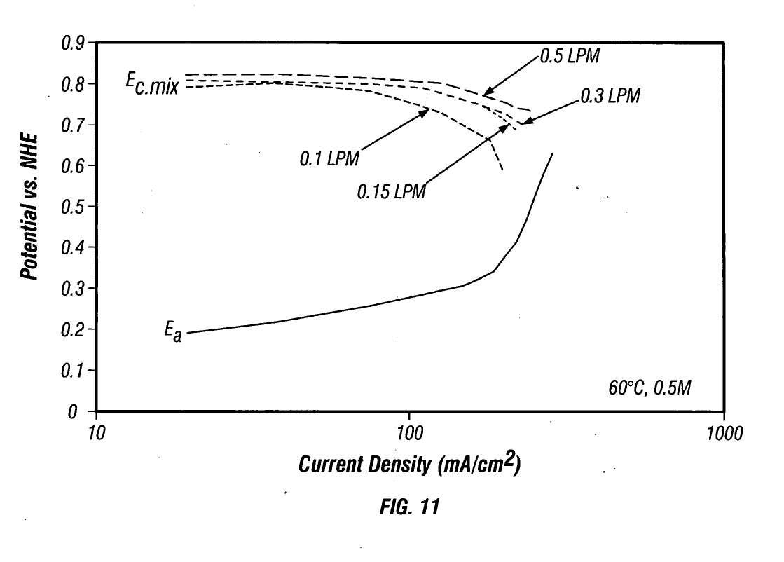

The effect of airflow rate on cathode performance can be best understood by separating the cathode from the full cell performance through the technique of anode polarization as shown in FIG. 11. The cathode potentials, Ec, mix, at varied airflow rates can be compared. The effects of air stoichiometry at the cathode manifest themselves as mass transfer limitations at high current densities. As can be seen in FIG. 11, the cathode potentials are steady for all airflow rates at current densities less than 60 mA/cm². At applied current densities of 100 cm², a cell operating at 0.1 LPM airflow begins to operate in a mass transfer limited regime. The air stoichiometry at 0.1 LPM airflow and 100 mA/cm² applied current density is 1.54 time stoich (including crossover). The cathode potentials are steady at 100 mA/cm² for airflow rates of 0.15 LPM or greater. The air stoichiometry at an airflow of 0.15 LPM and at an applied current density of 100 mA/cm² is 2.56 times stoic (including crossover). There is little variation in cathode potentials for airflow rates above 0.15 LPM for all applied current densities.

FIG. 3 is an anode polarization experiment performed with 90° C. 1M methanol. MEA 1 and 2 are of the Type 3, MEA 3 is of the Type 4. The anode of MEA 1 has a catalyst loading of 4 mg/cm², the anode of MEA 2 has a catalyst loading of 8 mg/cm², and the anode of MEA 3 has a catalyst loading of 4 mg/cm² brush coated on top of a layer of hydrous RuO₂. As can be seen in FIG. 3, the addition of hydrous RuO₂ to the catalyst interface improves anode performance. At an applied current density of 100 mA/cm² the anode over potential decreased from 0.257 to 0.224 V versus NHE for MEA 1 versus MEA 3. The performance of the MEA 3 is comparable to MEA 2 for current densities less than 500 MA/cm². Another property that was noticed was that the internal cell resistance was lower for the MEA 3 as compared to MEA 1. The internal resistance for the cells at 90° C., averaged over the range of current densities, is 7.5 and 4.6 mΩ for MEA 1 and MEA 3 respectively. As shown in FIG. 3, an electrically conducting/proton conducting interface is a key to improved catalysis in PEM based fuel cells. At current densities higher than 500 mA/cm², the higher catalyst-loading anode of MEA 2 exhibits better characteristics of methanol oxidation since the turnover rates on the catalyst become important.

The increase in cell performance from the Type 1 to Type 2 and Type 2 to Type 3 DMFC can be attributed to improvements at the anode and cathode of the respective MEAs. The Type 3 DMFC achieved the highest peak operating efficiency, current density at peak efficiency and peak power of 28.9%, 55.68 mW/cm² and 66.1 mW/cm² respectively operating on 60° C. 1M MeOH at 1.6 times air stoichiometry.

The effects of crossover on the cathode of a DMFC can be mitigated by the addition of hydrophobic particles. The location of the hydrophobic particles in the cathode structure determine the ability to sustain higher current densities as shown by the cathode polarization plots. Anode structure has a strong effect on anode polarization in DMFCs. The denser anodes of the Type 1 and Type 2 MEAs exhibited higher over-potentials as compared to that of the Type 3 MEA. The anode potentials at an applied load of 100 mA/cm² are 0.379, 0.342, and 0.273 V versus NHE for the Type 1,2, and 3 MEAs respectively. The Type 3 MEA has the best characteristics for low airflow rates. Power densities as high as 70 mW/cm² can be attained at 1.76 stoic and 80 mW/cm² at 5.4 stoic at 60° C. The use of hydrophobic particles in the gas diffusion backing is key to attaining high cell performance at low airflow.

The addition of hydrous ruthenium oxide to the anode membrane interface lowers the anode over-potential and allows for improved utilization of the catalyst. The addition of hydrous RuO₂ can also decrease the internal cell resistance of a DMFC. Electrically conductive proton conducting additives enhance the utilization of the catalyst and thus offer an alternative path to catalyst reduction.

Although only a few embodiments have been described in detail above, those having ordinary skill in the art will certainly understand that many modifications are possible with respect to the described embodiments without departing from the teachings thereof. All such modifications are intended to be encompassed within the following claims.

What is claimed is:

1. A proton-electron conducting ink for a fuel cell comprising hydrous ruthenium oxide.

2. The proton-electron conducting ink of claim 1, further comprising an ionomer.

3. The proton-electron conducting ink of claim 1, wherein the ionomer comprises a liquid copolymer of tetrafluoroethylene and perfluorovinylethersulfonic acid.

4. A process for making a proton-electron conducting ink for a fuel cell, comprising mixing, at room temperature, components comprising ruthenium oxide, an ionomer solution and water.

5. The process of claim 4, wherein the ionomer comprises a liquid copolymer of tetrafluoroethylene and perfluorvinyletherosulfonic acid.

6. The process of claim 4, wherein the mixture is sonicated.

7. A process for making an electrode assembly for a fuel cell, comprising:
(a) providing a proton-electron conducting ink comprising water, ruthenium oxide, and an ionomer material; and
(b) applying the proton-electron conducting ink at room temperature to at least one side of a substrate.

8. The process of claim 7, wherein the substrate is a membrane.

9. The process of claim 8, further comprising roughening a surface of the membrane prior to applying the catalyst ink.

10. The process of claim 9, wherein the surface is roughened by contacting the membrane with an abrasive selected from the group consisting of silicon nitride, boron nitride, silicon carbide, silica and boron carbide.

11. A fuel cell electrode comprising a backing material, a catalyst layer, and a proton-electron conducting layer comprising ruthenium oxide on the backing material.

12. The fuel cell electrode of claim 11, wherein the hydrous ruthenium oxide is about 4 mg/cm².

13. The fuel cell electrode of claim 11, wherein the backing material is a carbon paper.

14. The fuel cell electrode of claim 11, wherein the catalyst layer is applied to the backing before the proton-electron conducting layer comprising the ruthenium oxide is applied.

15. A membrane electrode assembly, comprising:
an anode electrode comprising a backing material and a first catalyst;
a proton conducting electrolyte membrane comprising a proton-electron conducting layer of hydrous ruthenium oxide; and
a cathode electrode comprising a second catalyst;
wherein the anode, cathode and electrolyte membrane are press bonded to one another in that order so that the electrolyte membrane is between the anode and cathode electrodes and wherein the proton-electron conducting layer is in contact with the catalyst layer of the anode.

16. The membrane electrode assembly of claim 15, wherein the backing material is carbon paper.

17. The membrane electrode assembly of claim 15, further comprising a sintered layer having a waterproofing amount of polytetrafluoroethylene.

18. The membrane electrode assembly of claim 15, wherein the catalyst comprises a copolymer of tetrafluoroethylene and perfluorovinylether sulfonic acid.

19. The membrane electrode assembly of claim 15, wherein the cathode catalyst comprises platinum.

20. The membrane electrode assembly of claim 15, wherein the electrolyte membrane comprises a co-polymer of tetrafluroethylene and perflurovinylether sulfonic acid.

21. A fuel cell comprising a fuel cell electrode of claim 11.

22. A fuel cell comprising a membrane electrode assembly of claim 15.

23. A fuel cell comprising:
an anode and a cathode chamber;
a proton conducting membrane comprising a proton-electron conducting layer of hydrous ruthenium oxide separating the anode and cathode chambers; and
at least anode and cathode electrodes, wherein the electrodes include a backing material, and a catalyst layer in electrical communication with the proton conducting membrane, and wherein the catalyst layer of the anode is in contact with the proton-electron conducting layer comprising hydrous ruthenium oxide.

24. The fuel cell of claim 23, wherein the backing material is carbon paper.

25. The fuel cell of claim 23, further comprising a sintered catalyst layer having a waterproofing amount of polytetrafluoroethylene.
